(19) United States
(12) Patent Application Publication
(10) Pub. No.: US 2013/0099451 A1
(43) Pub. Date: Apr. 25, 2013

(54) SELF-SEALING GASKET

(71) Applicants: Judson B. Estes, Milford, MI (US); Scott D. VanBrocklin, Clarkston, MI (US)

(72) Inventors: Judson B. Estes, Milford, MI (US); Scott D. VanBrocklin, Clarkston, MI (US)

(21) Appl. No.: 13/659,070

(22) Filed: Oct. 24, 2012

Related U.S. Application Data
(60) Provisional application No. 61/551,111, filed on Oct. 25, 2011.

(51) Int. Cl. F02F 11/00

(52) U.S. Cl. 277/594; 277/591

(57) ABSTRACT

A system may include a first member, a second member, a gasket and a pressurized fluid. The first member may include a first recess. The second member may include a second recess adjacently opposing the first recess. The second member may matingly engage the first member and may define a volume therebetween. The gasket may include a cross section having opposing first and second legs and a central portion disposed therebetween. The first leg may be received in the first recess. The second leg may be received in the second recess. The pressurized fluid may be disposed between the first and second legs and may urge the first and second legs into sealing engagement with the first and second recesses, respectively.

### CROSS-REFERENCE TO RELATED APPLICATION

This application claims the benefit of U.S. Ser. No. 61/551,111, filed Oct. 25, 2011.

### FIELD

The present invention relates to a gasket, and more particularly to a self-sealing gasket.

### BACKGROUND

Gaskets may be used in a variety of applications to seal a joint between mating components to fluidly isolate a first volume from a second volume. For example, a gasket may be used to seal a variety of mating and adjacent components of an internal combustion engine. Robust seals between mating parts may facilitate efficient, reliable and clean operation of the internal combustion engine and a vehicle in which the engine is installed.

### SUMMARY

In one form, the present disclosure provides a system that may include a first member, a second member, a gasket and a pressurized fluid. The first member may include a first recess. The second member may include a second recess adjacently opposing the first recess. The second member may matingly engage the first member and may define a volume therebetween. The gasket may include a cross section having opposing first and second legs and a central portion disposed therebetween. The first leg may be received in the first recess. The second leg may be received in the second recess. The pressurized fluid may be disposed between the first and second legs and may urge the first and second legs into sealing engagement with the first and second recesses, respectively.

In another form, the present disclosure may include an apparatus that may include a first member, a second member, and an annular gasket. The first member may include a first recess. The second member may cooperate with the first member to define a cavity therebetween and may include a second recess disposed adjacent the first recess. The annular gasket may include a substantially U-shaped cross section having first and second legs and a central portion disposed therebetween. The first and second legs may engage the first and second recesses, respectively. A fluid-pressure differential between a first fluid inside of the cavity and a second fluid outside of the cavity may urge the first and second legs into sealed engagement with the first and second recesses, respectively.

Further areas of applicability of the present disclosure will become apparent from the detailed description, drawings and claims provided hereinafter. It should be understood that the detailed description, including disclosed embodiments and drawings, are merely exemplary in nature, intended for purposes of illustration only, and are not intended to limit the scope of the invention, its application, or use. Thus, variations that do not depart from the gist of the invention are intended to be within the scope of the invention.

### BRIEF DESCRIPTION OF THE DRAWINGS

FIG. 1 is a partial cross-sectional view of an internal combustion engine including a gasket according to the principles of the present disclosure;

FIG. 2 is a partial cross-sectional view of the gasket engaging mating components according to the principles of the present disclosure;

FIG. 3 is a partial exploded perspective view of the internal combustion engine of FIG. 1; and

FIG. 4 is a partial cross-sectional view of another gasket according to the principles of the present disclosure.

### DETAILED DESCRIPTION

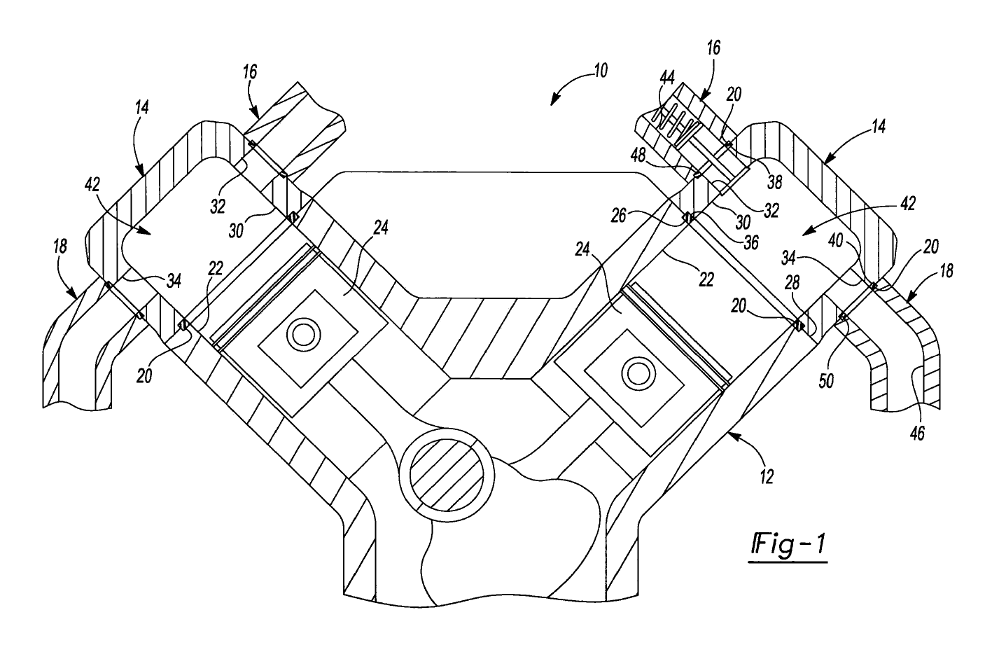

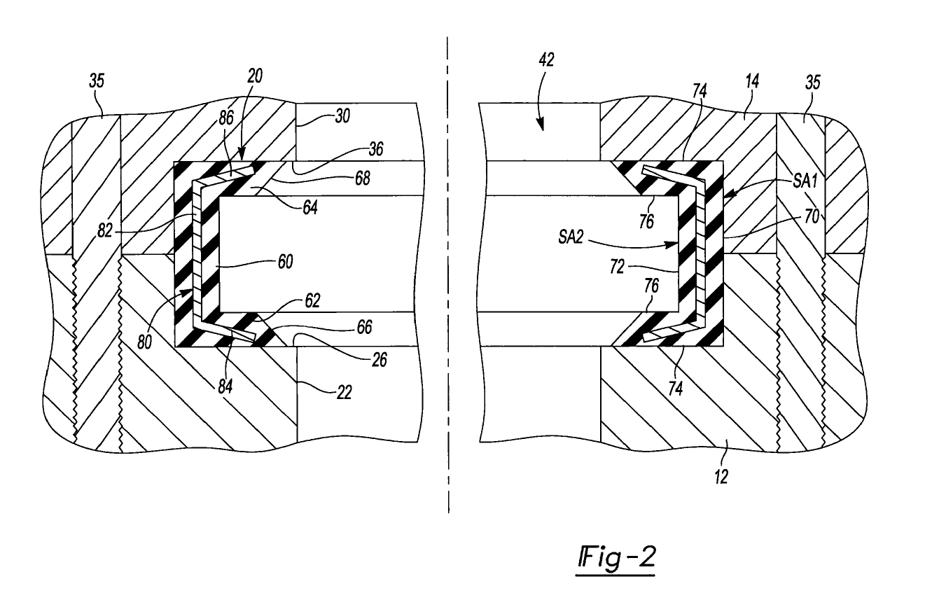

With reference to FIGS. 1-4, an engine 10 is provided that may include a cylinder block 12, one or more cylinder heads 14, one or more intake manifolds 16, one or more exhaust manifolds 18, and one or more gaskets 20. Each of the gaskets 20 may seal a joint between the cylinder block 12 and one of the heads 14, or between one of the cylinder heads 14 and one of the intake or exhaust manifolds 16, 18, for example. It will be appreciated, however, that the gasket 20 could be used to seal a joint between any mating components, including, for example, a joint fluidly coupling adjacent engine coolant passages. It will be appreciated that the principles of the present disclosure are not limited in application to engines or to components or subsystems associated with an engine. As will be subsequently described, the gaskets 20 may be self-sealing gaskets, as each of the gaskets 20 may utilize pressure of a fluid within a space to be sealed by the gasket 20 to increase a biasing force sealing the gasket 20 against a mating component.

The cylinder block 12 may define one or more cylindrical bores 22 that each receive a piston 24 for reciprocating motion therein. A plurality of first annular recesses 26 may be formed in a distal surface 28 of the cylinder block 12 and may surround each of the cylindrical bores 22. Each of the first annular recesses 26 may include a generally L-shaped cross section and may partially engage a corresponding one of the gaskets 20.

Each of the cylinder heads 14 may include one or more cavities 30, one or more intake ports 32 corresponding to each of the cavities 30, and one or more exhaust ports 34 corresponding to each of the cavities 30. Each cylinder head 14 may be secured via fasteners 35 to corresponding distal surfaces 28 of the cylinder block 12 such that the cavities 30 are aligned with the corresponding cylindrical bores 22. In this manner, each of the cavities 30 may cooperate with the corresponding cylindrical bore 22 and piston 24 to define a combustion chamber 42.

Each cylinder head 14 may include one or more second annular recesses 36, one or more third annular recesses 38 and one or more fourth annular recesses 40. Each of the second annular recesses 36 may be disposed around a corresponding cavity 30 and may include a generally L-shaped cross section that is substantially aligned with the first annular recess 26 in the cylinder block 12. The second annular recesses 36 may cooperate with the first annular recesses 26 to engage corresponding gaskets 20. The third and fourth annular recesses 38, 40 may be formed in distal ends of the intake and exhaust ports 32, 34, respectively, and may include substantially L-shaped cross sections.

The intake manifolds 16 and exhaust manifolds 18 may include intake and exhaust passages 44, 46, respectively, that are in selective communication with the combustion chamber 42. Air and/or fuel may be delivered to the combustion chamber 42 through the intake passages 44 during an intake stroke of the engine 10. Combustion gases may exit the combustion chamber 42 through the exhaust passages 46 during an exhaust stroke of the engine 10. The intake manifolds 16 may include fifth annular recesses 48 that surround the intake passages 44 and include L-shaped cross-sections. The exhaust manifolds 18 may include sixth annular recesses 50 that surround the exhaust passages 46 and include L-shaped cross-sections. The third and fourth annular recesses 38, 40 may cooperate with the fifth and sixth annular recesses 48, 50, respectively, to engage corresponding gaskets 20.

The gaskets 20 may be formed from nylon, for example, or any other suitable resilient polymeric or elastomeric material. Each of the gaskets 20 may include a generally U-shaped cross section and may include a central portion 60 and first and second legs 62, 64 extending radially inward from opposing ends of the central portion 60. The first and second legs 62, 64 may include first and second end surfaces 66, 68, respectively, that are spaced apart from the central portion 60. The first and second legs 62, 64 may be tapered such that the first and second end surfaces 66, 68 may face radially inward and axially inward.

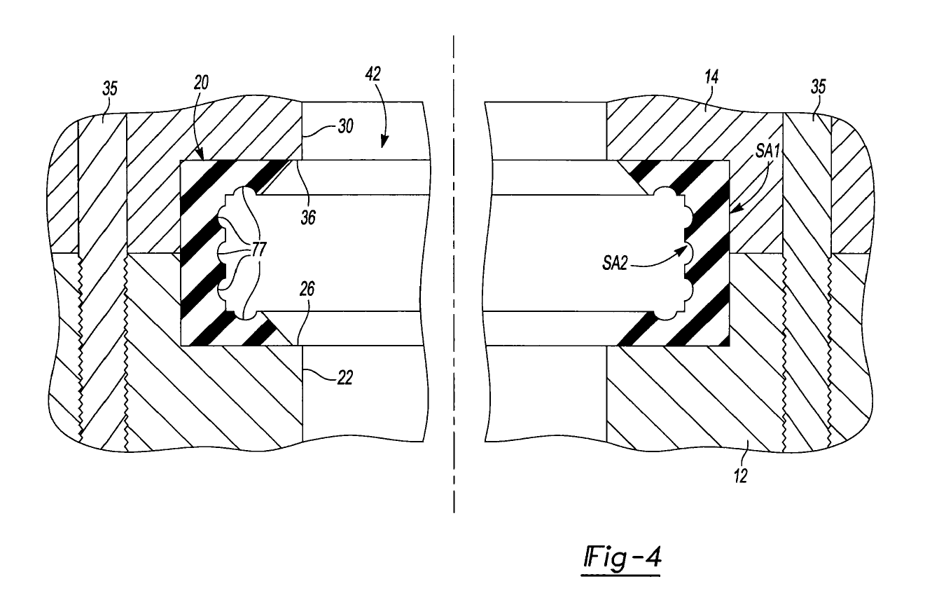

The central portion 60 may include a radially outward surface 70 and a radially inward surface 72. Each of the first and second legs 62, 64 may include axially outward surfaces 74 and axially inward surfaces 76. The radially outward surface 70 and axially outward surfaces 74 may cooperate to define an outer surface area SA1 of the gasket 20. The first and second end surfaces 66, 68, the radially inward surface 72 and the axially inward surfaces 76 may cooperate to define an inner surface area SA2 of the gasket 20. In some embodiments, the relative shapes, sizes, and thicknesses of the central portion 60 and the first and second legs 62, 64 may be configured such that the inner surface area SA2 is greater than the outer surface area SA1. In some embodiments, the inner surface area SA2 may include dimples 77 (FIG. 4) and/or other surface contours or features to increase the inner surface area SA2 relative to the outer surface area SA1.

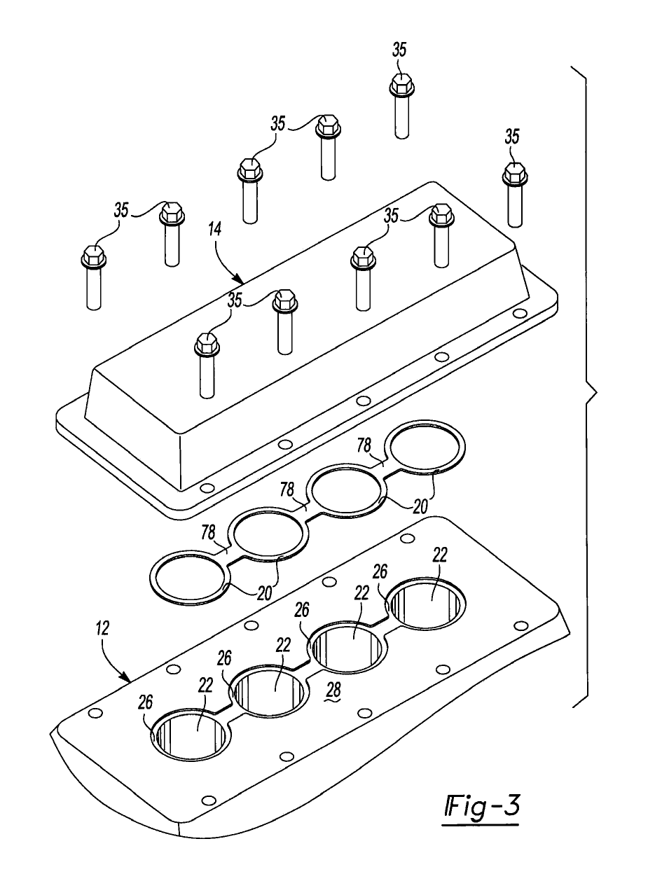

In some embodiments, a plurality of gaskets 20 may be interconnected with each other. As shown in FIG. 3, each of a plurality of connectors 78 may disposed between and interconnect adjacent gaskets 20. The plurality of gaskets 20 and the connectors 78 may be integrally formed with each other.

In some embodiments, the gasket 20 may include a spring member 80 embedded therein. The spring member 80 may be an annular member having a generally U-shaped cross section and may be formed from a resiliently flexible metallic material such as steel, for example. The spring member 80 may include a central portion 82 and first and second legs 84, 86 extending radially inward and axially outward from opposing ends of the central portion 82. The central portion 82 of the spring member 80 may be disposed between the radially outward and inward surfaces 70, 72 of the central portion 60 of the gasket 20 and may extend at least partially through the central portion 60 between the first and second legs 62, 64 of the gasket 20. The first and second legs 84, 86 of the spring member 80 may extend at least partially through the first and second legs 62, 64, respectively. The generally radially inward and axially outward direction in which the first and second legs 84, 86 extend through the first and second legs 62, 64 of the gasket 20 may bias the first and second legs 62, 64 axially outward into sealing engagement with corresponding ones of the recesses 26, 36, 38, 40, 48, 50.

With continued reference to FIGS. 1-4, operation of the gaskets 20 will be described in detail. As described above, each of the gaskets 20 may seal a joint between the cylinder block 12 and one of the cylinder heads 14, or a joint between one of the cylinder heads 14 and one of the intake or exhaust manifolds 16, 18, for example. The gaskets 20 may utilize a fluid-pressure differential to bias the central portion 60 and the first and second legs 62, 64 radially and axially outward, respectively, against the corresponding recesses 26, 36, 38, 40, 48, 50 to enhance the sealing engagement therebetween, thereby enhancing a capacity of the gaskets 20 to seal the corresponding joints. Further details of the operation of the gaskets 20 will be described with reference to operation of the particular gasket 20 that seals one of the combustion chambers 42 defined by the cylinder block 12 and cylinder head 14. It will be appreciated that the principles of operation of the gaskets 20 that seal the joints between the cylinder head 14 and the intake and exhaust manifolds 16, 18 (i.e., the gaskets 20 engaging third, fourth, fifth and sixth annular recesses 38, 40, 48, 50) may be substantially similar as the principles of operation of the gasket 20 that seals the combustion chamber 42.

During assembly of the engine 10, the gasket 20 may be installed into the first annular recess 26 surrounding the cylindrical bore 22 such that the first leg 62 and a portion of the central portion 60 are engaging the first annular recess 26. Then, the cylinder head 14 may be installed onto the cylinder block 12 such that the second annular recess 36 engages another portion of the central portion 60 and the second leg 64 of the gasket 20. The cylinder head 14 may be bolted in place with the fasteners 35. The fasteners 35 may exert a compression force urging the cylinder head 14 and the cylinder block 12 toward each other. The compression force also urges the first and second recesses 26, 36 toward each other and compresses the gasket 20 therebetween. This compression of the gasket 20 and/or the axially outward biasing force of the spring member 80 urging the first and second legs 62, 64 into engagement with the first and second recesses 26, 36, respectively, provides an initial sealing engagement therebetween. In this manner, the combustion chamber 42 may be substantially sealed from the ambient atmosphere surrounding the engine 10.

During operation of the engine 10, a fluid pressure within the combustion chamber 42 may rise, thereby increasing a fluid-pressure differential between the combustion chamber 42 and the ambient atmosphere. This fluid-pressure differential may exert net radially and axially outward forces on the inner surface area SA2 of the gasket 20, thereby increasing the biasing force sealing the central portion 60 and the first and second legs 62, 64 against the first and second annular recesses 26, 36. Therefore, the greater the pressure differential between the combustion chamber 42 and the ambient environment, the greater the biasing force urging the gasket 20 into sealing engagement with the first and second annular recesses 26, 36. In this manner, the capacity of the gasket 20 to seal the combustion chamber 42 increases as the fluid pressure within the combustion chamber 42 increases, thereby reducing or preventing leakage of fluid out of the combustion chamber 42 between the cylinder block 12 and the cylinder head 14. This self-sealing operation of the gasket 20 may allow the gasket 20 to seal spaces containing fluid at extremely high pressures.

What is claimed is:

1. A system comprising:
a first member including a first recess;
a second member including a second recess adjacently opposing said first recess, said second member matingly engaging said first member and defining a volume therebetween;
a gasket including a cross section having opposing first and second legs and a central portion disposed therebetween, said first leg received in said first recess, said second leg received in said second recess; and
a pressurized fluid disposed between said first and second legs and urging said first and second legs into sealing engagement with said first and second recesses, respectively.

2. The system of claim 1, wherein said gasket includes an annular member.

3. The system of claim 1, wherein said first and second legs and said central portion cooperate to form a generally U-shape.

4. The system of claim 1, wherein said gasket includes a radially inner surface area and a radially outer surface area that is smaller than said radially inner surface area.

5. The system of claim 1, wherein said first and second recesses cooperate to form a generally U-shaped cross section.

6. The system of claim 1, further comprising a fastener engaging said first and second members and urging said first and second recesses into sealed engagement with said first and second legs.

7. The system of claim 1, wherein said gasket includes a spring member biasing said first leg into engagement with said first recess.

8. The system of claim 7, wherein said spring member extends through at least a portion of said first leg, said central portion and said second leg and biases said first and second legs away from each other and into sealed engagement with said first and second recesses, respectively.

9. The system of claim 1, wherein said gasket is integrally formed with a plurality of other gaskets including cross sections having opposing first and second legs and central portions disposed therebetween.

10. The system of claim 1, wherein one of said first and second members includes an engine cylinder block and another of said first and second members includes an engine cylinder head.

11. An apparatus comprising:
a first member including a first recess;
a second member cooperating with said first member to define a cavity therebetween and including a second recess disposed adjacent said first recess; and
an annular gasket including a substantially U-shaped cross section having first and second legs and a central portion disposed therebetween, said first and second legs engaging said first and second recesses, respectively,
wherein a fluid-pressure differential between a first fluid inside of said cavity and a second fluid outside of said cavity urges said first and second legs into sealed engagement with said first and second recesses, respectively.

12. The apparatus of claim 11, wherein said gasket includes a radially inner surface area and a radially outer surface area that is smaller than said radially inner surface area.

13. The apparatus of claim 11, wherein said first and second recesses cooperate to form a generally U-shaped cross section.

14. The apparatus of claim 11, further comprising a fastener engaging said first and second members and urging said first and second recesses into sealed engagement with said first and second legs.

15. The apparatus of claim 11, wherein said gasket includes a spring member biasing said first leg into engagement with said first recess.

16. The apparatus of claim 15, wherein said spring member extends through at least a portion of said first leg, said central portion and said second leg and biases said first and second legs away from each other and into sealed engagement with said first and second recesses, respectively.

17. The apparatus of claim 11, wherein said gasket is integrally formed with a plurality of other gaskets including cross sections having opposing first and second legs and central portions disposed therebetween.

18. The apparatus of claim 11, wherein one of said first and second members includes an engine cylinder block and another of said first and second members includes an engine cylinder head.

19. The apparatus of claim 11, wherein said first fluid includes at least one of air, fuel, and exhaust gas.

20. The apparatus of claim 19, wherein said second fluid includes ambient air.
